(19) United States
(12) Patent Application Publication
(10) Pub. No.: US 2026/0081161 A1
(43) Pub. Date: Mar. 19, 2026

(54) METHOD OF MANUFACTURING ELECTRODE-LAMINATED BODY MODULE

(71) Applicant: TOYOTA JIDOSHA KABUSHIKI KAISHA, Toyota-shi (JP)

(72) Inventors: Satoshi NAKASHIMA, Toyota-shi (JP); Atsushi SUGIHARA, Toyota-shi (JP); Jun IZUMI, Toyota-shi (JP)

(73) Assignee: TOYOTA JIDOSHA KABUSHIKI KAISHA, Toyota-shi (JP)

(21) Appl. No.: 19/185,757

(22) Filed: Apr. 22, 2025

(30) Foreign Application Priority Data
Sep. 19, 2024 (JP) 2024-162349

(51) Int. Cl. H01M 4/62; H01M 4/02; H01M 4/36; H01M 10/0567; H01M 10/0568; H01M 10/0569; H01M 10/0585

(52) U.S. Cl. CPC H01M 4/62; H01M 4/368; H01M 10/0567; H01M 10/0568; H01M 10/0569; H01M 10/0585; H01M 2004/027; H01M 2004/028; H01M 2300/0028

(57) ABSTRACT

A method of manufacturing an electrode laminated-body module of the present disclosure includes (a) producing an electrode laminated body by laminating a positive-electrode active material layer, a separator, and a negative-electrode active material layer in the stated order, and (b) injecting an electrolytic solution into an electrode laminated-body module including the electrode laminated body and an exterior body. In (a), at least one of the positive-electrode active material layer, the separator, and the negative-electrode active material layer has an ethylene carbonate layer on at least a part of a front surface thereof.

### CROSS-REFERENCE TO RELATED APPLICATION

This application claims priority to Japanese Patent Application No. 2024-162349 filed on Sep. 19, 2024. The disclosure of the above-identified application, including the specification, drawings, and claims, is incorporated by reference herein in its entirety.

### BACKGROUND

### 1. Technical Field

The present disclosure relates to a method of manufacturing an electrode laminated-body module.

### 2. Description of Related Art

The electrode laminated-body module is a battery obtained by housing an electrode laminated body having a positive-electrode current collector layer, a positive-electrode active material layer, an electrolyte layer, a negative-electrode active material layer, and a negative-electrode current collector layer in the stated order in an outer container and the like, for example.

For example, in Japanese Unexamined Patent Application Publication No. 2023-000059 (JP 2023-000059 A), a method of manufacturing an electricity storage apparatus is disclosed. The method includes a preparing step of preparing a laminated body including a plurality of current collectors each having an active material layer provided thereon and a plurality of sealing members each exhibiting a frame form that surrounds the active material layer when seen from the thickness side of the current collector and each having an extending portion that extends to the outer side from an outer edge of the current collector such that the sealing member is arranged between each of the plurality of current collectors, a melting step of forming a side surface configured by the plurality of sealing members and including a communication port that provides communication between the inside and the outside of the laminated body by causing the plurality of sealing members to melt, and a molding step of forming a molding surface to which an equipment side nozzle is pressed in a region that surrounds the communication port out of the side surface formed by causing the plurality of sealing members to melt. In the melting step, the plurality of sealing members are caused to melt by non-contact heating. In the molding step, the molding surface is formed by pressing a pressing member having a temperature lower than the melting point of the sealing member to the side surface in a state in which the sealing member has melted. With the method according to JP 2023-000059 A, it is conceived that the improvement of productivity and the securing of sealing property can be realized.

For example, in Japanese Unexamined Patent Application Publication No. 2021-140971 (JP 2021-140971 A), an electricity storage cell is disclosed. The electricity storage cell includes a first electrode unit and a second electrode unit laminated on each other, a separator interposed between the first electrode unit and the second electrode unit, and an electrolytic solution held by the first electrode unit and the second electrode unit. The first electrode unit has a first current collector including a first surface, a first active material layer formed on the first surface, and a first resin frame provided on the first surface so as to surround the first active material layer. The second electrode unit includes a second current collector including a second surface, a second active material layer that is formed on the second surface and has a polarity different from that of the first active material layer, and a second resin frame provided on the second surface so as to surround the second active material layer. The first electrode unit and the second electrode unit are laminated such that the first active material layer and the second active material layer face each other over the separator. The first resin frame and the second resin frame seal a space between the first current collector and the second current collector by being joined to each other. The electrolytic solution is arranged in the space. The height of the first active material layer from the first surface is lower than the height of the first resin frame from the first surface. The height of the second active material layer from the second surface is higher than the height of the second resin frame from the second surface. With the electricity storage cell described in JP 2021-140971 A, it is conceived to enable drip injection of excess electrolytic solution.

For example, in Japanese Unexamined Patent Application Publication No. 2018-073464 (JP 2018-073464 A), a method of manufacturing a lithium-ion secondary battery is disclosed. The method includes manufacturing a negative electrode containing graphite, configuring an electrode group including the negative electrode and a positive electrode, preparing an electrolytic solution that contains ethylene carbonate and does not contain 1,2-dimethoxyethane, impregnating the electrode group with the electrolytic solution, decomposing at least a part of the ethylene carbonate by reduction by charging the electrode group impregnated with the electrolytic solution, and manufacturing a lithium-ion secondary battery by adding the 1,2-dimethoxyethane to the electrolytic solution after the charging. With the method according to JP 2018-073464 A, it is conceived that co-insertion of 1,2-dimethoxyethane is inhibited.

### SUMMARY

In recent years, there have been cases in which an electrolytic solution containing ethylene carbonate is used as an electrolytic solution. The electrolytic solution containing the ethylene carbonate has high viscosity. Therefore, when the electrolytic solution containing the ethylene carbonate is injected into an electrode laminated-body module including an electrode laminated body and an exterior body, the injection property and the impregnation property of the electrolytic solution is conceived to decrease.

Thus, an object of the present disclosure is to provide a method of manufacturing an electrode laminated-body module in which the injection property and the impregnation property of an electrolytic solution containing ethylene carbonate is improved.

The present disclosure achieves the object described above by measures below.

### First Aspect

A method of manufacturing an electrode laminated-body module includes (a) producing an electrode laminated body by laminating a positive-electrode active material layer, a separator, and a negative-electrode active material layer in the stated order, and (b) injecting an electrolytic solution into an electrode laminated-body module including the electrode laminated body and an exterior body. In (a), at least one of the positive-electrode active material layer, the separator, and the negative-electrode active material layer has an ethylene carbonate layer on at least a part of a front surface thereof.

### Second Aspect

In the method according to a first aspect, the content of ethylene carbonate in the electrolytic solution may be 15 volume % or less.

### Third Aspect

In the method according to the second aspect, the electrolytic solution may contain no ethylene carbonate.

### Fourth Aspect

In the method according to any one of the first aspect to the third aspect, the ethylene carbonate layer may be arranged on only a part of the front surface of at least one of the positive-electrode active material layer, the separator, and the negative-electrode active material layer.

### Fifth Aspect

In the method according to the fourth aspect, the ethylene carbonate layer may be arranged in a predetermined pattern on the front surface of at least one of the positive-electrode active material layer, the separator, and the negative-electrode active material layer.

With the present disclosure, it is possible to provide the method of manufacturing the electrode laminated-body module in which the injection property and the impregnation property of the electrolytic solution containing the ethylene carbonate are improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view for describing the present embodiment;

FIG. 2 is a schematic view for describing the present embodiment;

FIG. 3A is a schematic view for describing a predetermined pattern of the arrangement of ethylene carbonate;

FIG. 3B is a schematic view for describing a predetermined pattern of the arrangement of the ethylene carbonate;

FIG. 3C is a schematic view for describing a predetermined pattern of the arrangement of the ethylene carbonate; and

FIG. 3D is a schematic view for describing a predetermined pattern of the arrangement of the ethylene carbonate.

### DETAILED DESCRIPTION OF EMBODIMENTS

A method of manufacturing an electrode laminated-body module of the present disclosure includes (a) producing an electrode laminated body by laminating a positive-electrode active material layer, a separator, and a negative-electrode active material layer in the stated order, and (b) injecting an electrolytic solution into an electrode laminated-body module including the electrode laminated body and an exterior body. In (a), at least one of the positive-electrode active material layer, the separator, and the negative-electrode active material layer has an ethylene carbonate layer on at least a part of a front surface thereof.

With the method of manufacturing the electrode laminated-body module of the present disclosure, it is possible to improve the injection property and the impregnation property of the electrolytic solution containing the ethylene carbonate.

In a method of manufacturing an electrode laminated-body module of the related art, an electrolytic solution is injected by injecting an electrolytic solution containing ethylene carbonate from an injection port. In this case, the electrolytic solution containing the viscosity of the ethylene carbonate is higher than the viscosity of the electrolytic solution that does not contain the ethylene carbonate. Therefore, it is conceived that the injection property of the electrolytic solution is low, and the impregnation property with respect to an active material layer is low.

Meanwhile, with the method of the present disclosure, at least one of the positive-electrode active material layer, the separator, and the negative-electrode active material layer has an ethylene carbonate layer on at least a part of a front surface thereof when the electrode laminated body is produced. As a result, the content of the ethylene carbonate in the electrolytic solution to be injected can be reduced. Therefore, the viscosity of the electrolytic solution to be injected can be reduced. The melting point of the ethylene carbonate is about 36° C., and hence a solid ethylene carbonate layer can be formed in room temperature.

By arranging the ethylene carbonate layer on only a part of the front surface of at least one of the positive-electrode active material layer, the separator, and the negative-electrode active material layer, an injection passage of the electrolytic solution can be secured in a gap between the ethylene carbonate layers between the positive-electrode active material layer and the separator and/or between the separator and the negative-electrode active material layer. As a result, the injection property and the impregnation property of the electrolytic solution can be further improved.

An embodiment of the present disclosure is described in detail below. The present disclosure is not limited to the embodiment below and can be carried out by being variously modified without departing from the gist of the present disclosure. In the description of the drawings, the same elements are denoted by the same reference characters and overlapping descriptions are omitted.

### Laminating Process

In the method of manufacturing the electrode laminated-body module of the present disclosure, first, an electrode laminated body is produced by laminating a positive-electrode active material layer, a separator, and a negative-electrode active material layer in the stated order.

In the present disclosure, in the laminating process, at least one of the positive-electrode active material layer, the separator, and the negative-electrode active material layer has an ethylene carbonate layer on at least a part of a front surface thereof. It is preferred that at least one of the positive-electrode active material layer, the separator, and the negative-electrode active material layer have the ethylene carbonate layer on only a part of the front surface thereof. However, at least one of the positive-electrode active material layer, the separator, and the negative-electrode active material layer may have the ethylene carbonate layer on the entirety of the front surface thereof.

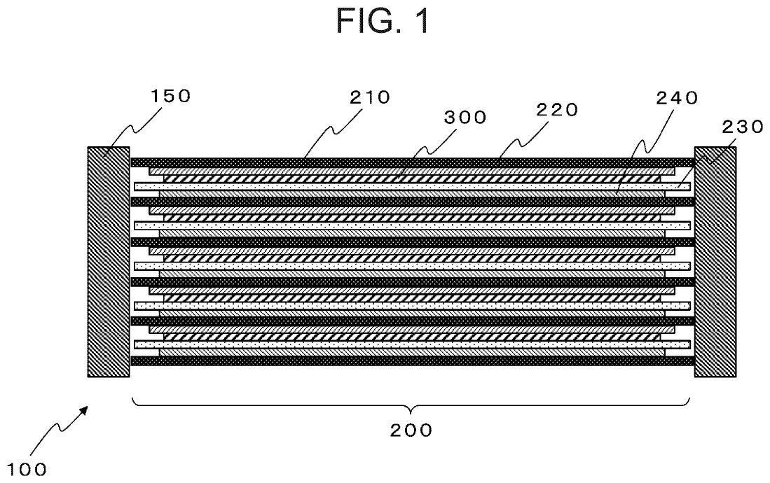

In FIG. 1, a sectional view of the electrode laminated body of the present embodiment is shown, but the embodiment in the present disclosure is not limited thereto. An electrode laminated body 200 is obtained by laminating a current collector 210, a negative-electrode active material layer 220 having an ethylene carbonate layer 300 on a front surface thereof, a separator 230, and a positive-electrode active material layer 240 in the stated order. In the electrode laminated body 200, the current collector 210, the negative-electrode active material layer 220, the ethylene carbonate layer 300, the separator 230, and the positive-electrode active material layer 240 are laminated in the stated order.

### Electrode Laminated Body

In the present disclosure, the electrode laminated body is not particularly limited, but may have a positive-electrode active material layer, an electrolyte layer, and a negative-electrode active material layer at least in the stated order.

In the present disclosure, the electrode laminated body may be a liquid-based electrode laminated body or may be a solid electrode laminated body. Regarding the present disclosure, a “solid-state battery” means a battery that uses at least a solid electrolyte as an electrolyte. Therefore, the solid-state battery uses a combination of a solid electrolyte and a liquid electrolyte as the electrolyte.

### Ethylene Carbonate Layer

In the present disclosure, in the laminating process, at least one of the positive-electrode active material layer, the separator, and the negative-electrode active material layer has an ethylene carbonate layer on at least a part of a front surface thereof.

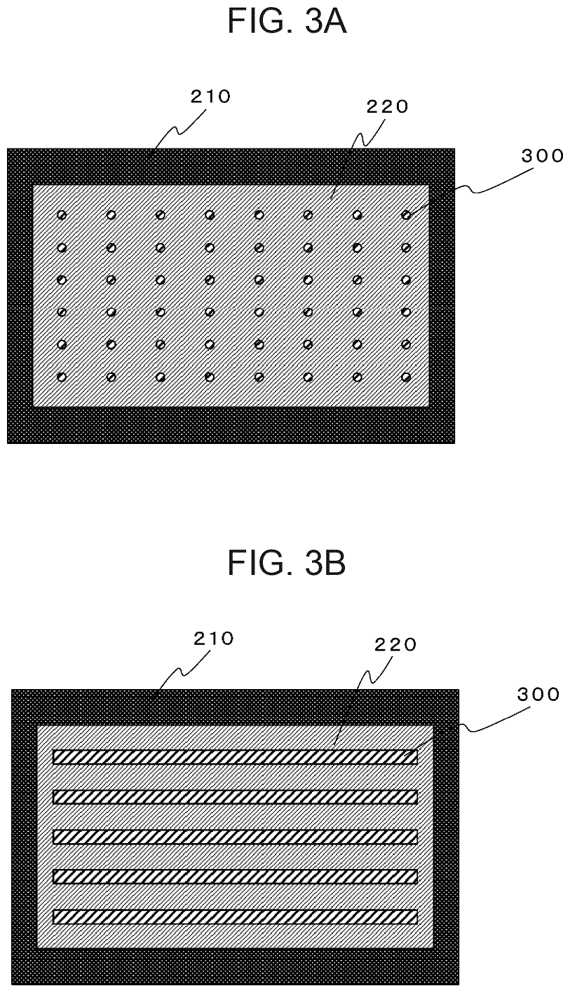

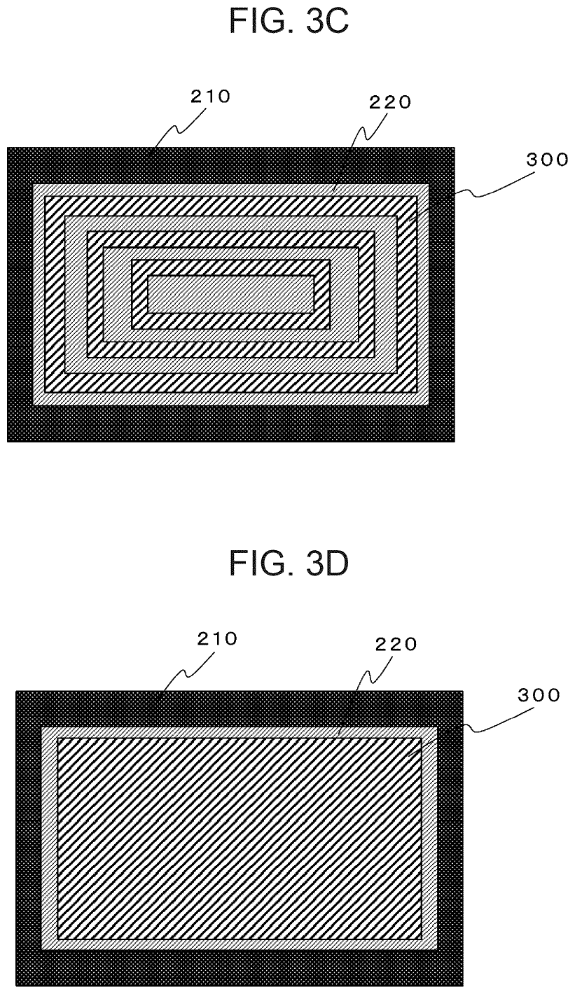

In the present disclosure, the ethylene carbonate layer may be arranged in a predetermined pattern on the front surface of at least one of the positive-electrode active material layer, the separator, and the negative-electrode active material layer. In the present disclosure, the predetermined pattern of the ethylene carbonate layer is not particularly limited. The negative-electrode active material layer seen from the lamination direction of the electrode laminated body in a case in which the ethylene carbonate layer is included on a part of the front surface of the negative-electrode active material layer is shown in FIG. 3A to FIG. 3D, but the embodiment in the present disclosure is not limited thereto. In the present disclosure, the predetermined pattern of the ethylene carbonate layer may be a dot form (FIG. 3A), a stripe form (FIG. 3B), a picture-frame form (FIG. 3C), or an entire surface arrangement (FIG. 3D), for example, and may be a spiral form, a checkered pattern form, a wave pattern form, a mesh pattern form, a geometric pattern form, or the like.

### Injecting Step

In the method of manufacturing the electrode laminated-body module of the present disclosure, next, an electrolytic solution is injected into the electrode laminated-body module including the electrode laminated body and an exterior body.

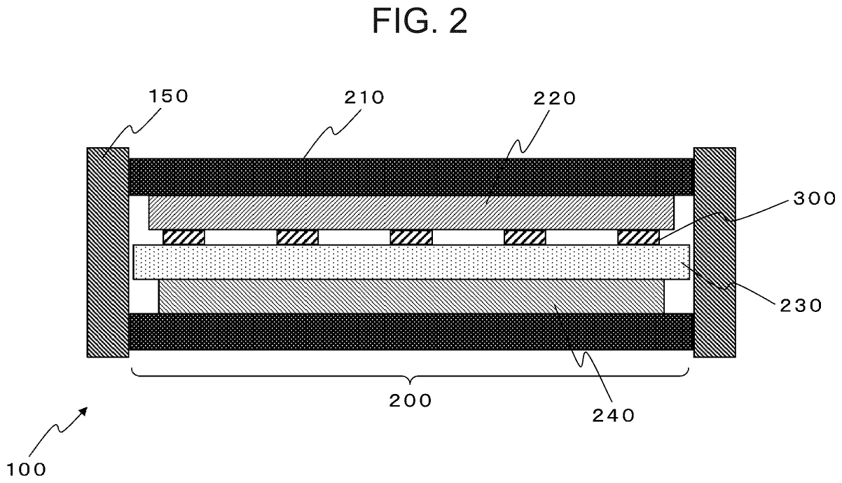

In FIG. 2, a sectional view of the electrode laminated body of the present embodiment is shown, but the embodiment of the present disclosure is not limited thereto. The electrode laminated body 200 has the ethylene carbonate layer 300 in some places between the negative-electrode active material layer 220 and the separator 230. Regarding the ethylene carbonate layer 300, sections out of a place between the negative-electrode active material layer 220 and the separator 230 in which the ethylene carbonate layer 300 is not arranged become gaps. In the electrode laminated-body module 100 in which the electrode laminated body 200 is sealed by a sealing member 150, the following occurs. When an electrolytic solution is injected in an injecting step, those gaps serve as passages, and the injected electrolytic solution can be diffused to the entire electrode laminated body 200. As a result, the negative-electrode active material layer 220 and/or the positive-electrode active material layer 240 is easily impregnated with the electrolytic solution.

In the present disclosure, the ethylene carbonate layer is arranged in the electrode laminated body, and the ethylene carbonate layer is caused to melt in the electrolytic solution injected in the injecting step by taking a sufficient amount of time. Therefore, even when the contained amount of the ethylene carbonate in the electrolytic solution to be injected in the injecting step is set to be smaller than a desired contained amount by the quantity arranged in the electrode laminated body, the electrolytic solution having the desired content of the ethylene carbonate can be obtained in the electrode laminated-body module.

### Electrolytic Solution

In the present disclosure, the electrolytic solution is injected into the electrode laminated-body module including the electrode laminated body and the exterior body in the injecting step.

In the present disclosure, the electrolytic solution is not particularly limited but preferably contains supporting salt and a solvent.

The supporting salt (lithium salt) of the electrolytic solution having lithium-ion conductivity is not particularly limited, but examples thereof include inorganic lithium salt and organic lithium salt. Examples of the inorganic lithium salt include LiPF₆, LiBF₄, LiClO₄, and LiAsF₆, but the inorganic lithium salt is not particularly limited to those cases. Examples of the organic lithium salt include LiCF₃SO₃, LiN(CF₃SO₂)₂, LiN(C₂F₅SO₂)₂, LiN(FSO₂)₂, and LiC(CF₃SO₂)₃, but the organic lithium salt is not limited to those cases.

The solvent used in the electrolytic solution is not particularly limited, but examples thereof include cyclic carbonate and chain carbonate. Examples of the cyclic carbonate include ethylene carbonate (EC), propylene carbonate (PC), and butylene carbonate (BC), but the cyclic carbonate is not limited to those cases. Examples of the chain carbonate include dimethyl carbonate (DMC), diethyl carbonate (DEC), and ethyl methyl carbonate (EMC), but the chain carbonate is not limited to those cases. The electrolytic solution is not particularly limited, but it is possible to use only one type or use two types or more in combination with each other.

In the present disclosure, when the electrolytic solution contains the ethylene carbonate, the content of the ethylene carbonate in the electrolytic solution is 0 volume % or more, 5 volume % or more, 7 volume % or more, 10 volume % or more, 15 volume % or more, or 20 volume % or more and 50 volume % or less, 40 volume % or less, 30 volume % or less, 25 volume % or less, 20 volume % or less, 15 volume % or less, or 10 volume % or less. In the present disclosure, the electrolytic solution to be injected in the injecting step does not necessarily need to contain the ethylene carbonate.

What is claimed is:

1. A method of manufacturing an electrode laminated-body module, the method comprising:
(a) producing an electrode laminated body by laminating a positive-electrode active material layer, a separator, and a negative-electrode active material layer in order of the positive-electrode active material layer, the separator, and the negative-electrode active material layer; and
(b) injecting an electrolytic solution into an electrode laminated-body module including the electrode laminated body and an exterior body,
wherein in (a), at least one of the positive-electrode active material layer, the separator, and the negative-electrode active material layer has an ethylene carbonate layer on at least a part of a front surface of the at least one of the positive-electrode active material layer, the separator, and the negative-electrode active material layer.

2. The method according to claim 1, wherein a content of ethylene carbonate in the electrolytic solution is 15 volume % or less.

3. The method according to claim 2, wherein the electrolytic solution contains no ethylene carbonate.

4. The method according to claim 1, wherein the ethylene carbonate layer is arranged on only a part of the front surface of at least one of the positive-electrode active material layer, the separator, and the negative-electrode active material layer.

5. The method according to claim 4, wherein the ethylene carbonate layer is arranged in a predetermined pattern on the front surface of at least one of the positive-electrode active material layer, the separator, and the negative-electrode active material layer.
